(19) United States
(12) Patent Application Publication
(10) Pub. No.: US 2004/0046350 A1
(43) Pub. Date: Mar. 11, 2004

(54) Method and apparatus for suspending a vehicular wheel assembly

(75) Inventors: J. Todd Wagner, East Haven, CT (US); Avery Jutkowitz, Berkeley, CA (US)

Correspondence Address: McCormick, Paulding & Huber LLP, CityPlace II, 185 Asylum Street, Hartford, CT, 06103-3402, US

(73) Assignee: Wagner Engineering, LLC, Rocky Hill, CT

(21) Appl. No.: 10/676,527

(22) Filed: Oct. 1, 2003

Related U.S. Application Data
(63) Continuation-in-part of application No. 10/152,083, filed on May 20, 2002, now Pat. No. 6,676,144.
(60) Provisional application No. 60/292,355, filed on May 21, 2001.

(51) Int. Cl. B60G 3/20

(52) U.S. Cl. 280/124.135

(57) ABSTRACT

A suspension for a vehicle having a body includes a first wheel assembly suspension that extends between a wheel assembly and the body and defines a first suspension plane. The suspension further includes a second wheel assembly suspension that extends between the wheel assembly and the body and defines a second suspension plane. A vertical plane extends through a vertical centerline of the wheel assembly and the intersection between the vertical plane and the first suspension plane defines a first line. The intersection between the vertical plane and the second suspension plane also defines a second line, the first line and the second line intersecting at an instant center that lies below a roll center of the vehicle. The first wheel assembly suspension and the second wheel assembly suspension do not cross one another when the first wheel assembly is viewed from either the front of rear of the vehicle.

### CROSS-REFERENCE TO RELATED APPLICATIONS

This is a Continuation-in-Part of U.S. patent application Ser. No. 10/152,083, filed on May 20, 2002, which claims the benefit of U.S. Provisional Application No. 60/292,355, filed May 21, 2001 and U.S. Provisional Application No. 60/499,305, filed Aug. 29, 2003, each of which are hereby incorporated by reference in their entireties. This application contains subject matter which is related to the subject matter of U.S. Pat. No. 6,173,978, issued Jan. 16, 2001, U.S. Pat. No. 6,550,797, issued Apr. 22, 2003 and U.S. patent application Ser. No. 10/385,404, filed on Mar. 10, 2003, each of which are hereby incorporated by reference in their entireties.

### FIELD OF THE INVENTION

This invention relates in general to vehicle suspensions systems, and deals more particularly with vehicle suspensions capable of controlling vehicle roll and pitch.

### BACKGROUND OF THE INVENTION

The suspension of a vehicle determines the ride characteristics of the vehicle such as its roll and pitch. The term “roll” refers to rotational movement of the vehicle body about a longitudinal axis of the vehicle. Roll is typically encountered during cornering. The term “pitch” refers to rotational movement of the vehicle body about a widthwise axis of the vehicle. Pitch is typically encountered during acceleration (acceleration “squat”) and during braking (braking “dive”).

Vehicle suspension systems can be characterized as either active or passive. Many fundamental aspects of vehicle suspension systems are discussed in reference tomes such as ‘Race Car Vehicle Dynamics’, by William F. Milliken and Douglas L. Milliken (1995), herein incorporated by reference in its entirety.

“Active” suspension systems typically adjust suspension elements during use in response to sensed operating conditions. Active suspension systems are often relatively complex, prohibitively expensive, or both. Passive suspension systems, on the other hand, typically include anti-roll or stabilizer bars, or the like that cannot be adjusted during use. Passive suspension systems are typically relatively simple and affordable.

In passive suspension systems that utilize elements such as springs and anti-roll bars to reduce cornering roll, there is a trade-off between reduction in roll and the smoothness of the ride. Spring and shock rates that increase the smoothness of the ride often counteract the effect of conventional anti-roll devices. Moreover, such anti-roll devices do not compensate for variations in weight distribution of the vehicle that can also significantly affect rolling characteristics.

With the forgoing problems and concerns in mind, it is the general object of the present invention to provide a vehicular suspension system which overcomes the above-described drawbacks while providing favorable roll and pitch characteristics.

### SUMMARY OF THE INVENTION

It is, therefore, an object to provide a vehicular suspension system that provides favorable roll and pitch characteristics.

According to the present invention, a suspension for a vehicle having a body is provided. The suspension includes a first wheel assembly suspension and a second wheel assembly suspension. The first wheel assembly suspension extends between a first wheel assembly and the body. The first wheel assembly suspension includes an instant center. The second wheel assembly suspension extends between a second wheel assembly and the body. The second wheel assembly suspension includes an instant center. The first wheel assembly and the second wheel assembly are aligned so that a vertical centerline of each wheel assembly lies within a vertical plane that extends therebetween. In one embodiment, the instant center of each wheel assembly suspension is located within the vertical plane, below a roll center located within the vertical plane.

According to a further aspect of the invention, a method for suspending a vehicle having a body is provided that includes the steps of: (1) providing a first wheel assembly suspension that extends between a first wheel assembly and the body, wherein the first wheel assembly suspension includes an instant center; (2) providing a second wheel assembly suspension that extends between a second wheel assembly and the body, wherein the second wheel assembly suspension includes an instant center; (3) aligning the first wheel assembly and the second wheel assembly so that a vertical centerline of each wheel assembly lies within a vertical plane that extends therebetween; and (4) positioning the first wheel assembly suspension and the second wheel assembly suspension so that the instant center of each wheel assembly suspension is located within the vertical plane, below a roll center located within the vertical plane.

An advantage of the present suspension is that it is possible to create a relatively high and stable roll center using the present suspension, and therefore a desirable stable vehicular suspension. The relatively high roll center can be maintained in approximately the same position during expected motion of the vehicle.

These and other objects, features, and advantages of the present invention will become apparent in light of the drawings and detailed description of the present invention provided below.

### BRIEF DESCRIPTION OF THE DRAWINGS

FIG. 1 is a diagrammatic front view of a vehicle showing the present suspensions.

FIG. 2 is a diagrammatic view of a support arm used within the present suspension.

FIG. 3 is a diagram showing relative plane positioning.

FIG. 4 is a diagram that illustrates the relationship of the support arm planes within a vertical transverse (or “widthwise”) extending plane passing through the vertical centerline of the wheels.

FIG. 5 is a diagram showing relative plane positioning.

FIG. 6 is a diagram that illustrates the relationship of the support arm planes within a longitudinally extending plane passing through the vertical centerline of the wheel.

FIG. 7 is a diagrammatic top view of a vehicle illustrating the orientation of the body mount lines of the present suspension relative to a longitudinally extending line.

FIG. 8 is a diagrammatic elevation view of the present suspension illustrating the position of the ball joint mounts relative to the wheel assembly.

FIG. 9 is a diagram that illustrates the relationship of the kingpin axis and the wheel assembly so that the positionability of the kingpin axis possible with the present suspension can be fully appreciated.

FIG. 10 is a diagrammatic view of an embodiment of the present suspension that includes a spring assembly.

FIG. 11 is a diagrammatic view of a spring assembly embodiment that can be used with the present invention suspension.

FIG. 12 is a diagrammatic view of a spring assembly embodiment that can be used with the present invention suspension.

FIGS. 13-15 are diagrams illustrating Ackermann steering geometry between the front wheels of a vehicle. FIG. 13 shows wheels having one-hundred percent Ackermann. FIG. 14 shows wheels having “neutral” Ackermann (also referred to as parallel orientation), and FIG. 15 shows wheels having reverse Ackermann.

FIG. 16 is a diagrammatic isometric view of a suspension system, according to another embodiment of the present invention.

FIG. 17 is a front schematic view of the suspension system illustrated in FIG. 16.

FIG. 18 is a diagrammatic isometric view of yet another embodiment of the suspension system.

FIG. 19 is a front schematic view of the roll center of the vehicle as the wheel assembly moves through its path.

### DETAILED DESCRIPTION OF THE INVENTION

A vehicular suspension is described herein that can be used on a wide variety of different vehicular applications. The suspension is used with independently suspended wheel assemblies. The wheel assembly may be driven or non-driven. Consequently, the suspension can be used with rear wheel drive (RWD), front wheel drive (FWD), and all wheel drive (AWD) vehicles.

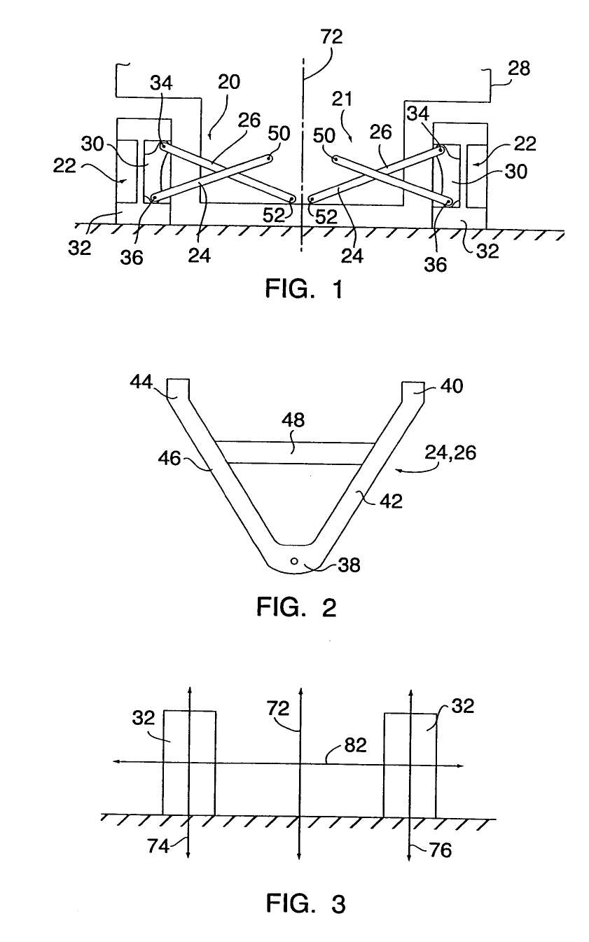

Referring to FIGS. 1 and 2, the present suspension 20,21 for a vehicular wheel assembly 22 includes a pair of support arms 24,26 extending between the body 28 of the vehicle and the wheel assembly 22. The terms “vehicle body” or “body of the vehicle” as used herein are defined as including the frame and chassis components attached thereto; e.g. sheet metal components, frame rails, doors, fenders, panels, interior, drivetrain, etc. In some vehicular applications, a subframe is coupled with structural components integrated into the sheet metal components of the vehicle in place of a conventional full frame. Other vehicular applications utilize a “unibody” style chassis that does not have an independent frame or subframe. Rather, all structural components are directly integrated into the sheet metal components of the vehicle. The present invention contemplates and is useful with all of these different types of vehicle bodies, and is not therefore limited to use with any one of the above.

The elements of the wheel assembly 22 will vary depending on the nature of the car (e.g., RWD, FWD, AWD) and in most instances also depend on the position of wheel assembly 22 on the vehicle. The wheel assembly 22 elements can be generally described as including a spindle 30 and a wheel (may also be referred to as a tire) 32. The spindle 30 includes an upper ball joint 34 and a lower ball joint 36. Rear suspensions do not typically include conventional ball joints, but rather include pivotable mount; e.g., bushings, etc. To simplify the description herein, the term “ball joint” is used herein, unless otherwise specified, to refer to any type of pivotal connection for connecting the support arm 24,26 to the spindle 30, including but not limited to, conventional ball joints, heim joints, bushings, etc. The wheel 32 is rotatably mounted on the spindle 30 in a manner known within the art.

Referring to FIG. 2, each support arm 24,26 includes a ball joint mount 38 (also referred to as a wheel assembly mount), a first body mount 40, a first member 42, a second body mount 44, and a second member 46. The first member 42 extends between the ball joint mount 38 and the first body mount 40. The second member 46 extends between the ball joint mount 38 and the second body mount 44. Some embodiments further include one or more lateral members 48 extending between the first and second members 42,46 to increase the rigidity of the support arm 24,26 and/or to provide an attachment point for additional suspension members (e.g., springs, shocks, etc.). The vehicle body 28 is pivotally attached to the support arm 24,26 at the first and second body mounts 40,44. In some instances, one or both body mounts 40,44 include a pliable bushing that provides a limited amount of motion in addition to rotational motion around a pivot axis extending between the body mounts 40,44. The ball joint mount 38 and the body mounts 40,44 in each support arm 24,26 define a plane. The first and second members 42,46 (and the lateral member(s) 48 if present) are not necessarily disposed in the plane of the support arm 24,26 of which they are a part, although they can be in some applications. The exact geometry of the first and second member 42,46 (and lateral member(s) 48) will vary to accommodate the application at hand.

Referring to FIGS. 1 and 3, the pair of support arms 24,26 extending between the body 28 of the vehicle and the wheel assembly 22 are arranged vis-à-vis the body 28 and the wheel assembly 22 such that one of the support arms 24 extends between the lower ball joint 36 and a pair of upper body mount connection points 50, and the other support arm 26 extends between the upper ball joint 34 and a pair of lower body mount connection points 52. The pair of upper body mount connection points 50 is disposed vertically above the pair of lower body mount connection points 52, although not necessarily in the same vertically extending plane, when the vehicle wheels 32 are in contact with or proximate the ground. The members 42,46 of one of the support arms 24,26 are received between the members 42,46 of the other support arm 26,24. Hence, the support arms 24,26 may be described as crossing one another in an “X” shaped arrangement, without normally touching one another.

The support arms 24,26 described above represent a preferred embodiment of the present invention, but do not represent all the possible embodiments of support arms 24,26. In alternative embodiments, one or both of the support arms 24,26 can be replaced with independent links that extend along paths similar to those of the above-described support arms 24,26; e.g., a pair of independent links, each including a ball joint mount 38 on one end and a body mount 40,44 on the opposite end. Independent links can be used in place of one or both of the support arms 24,26.

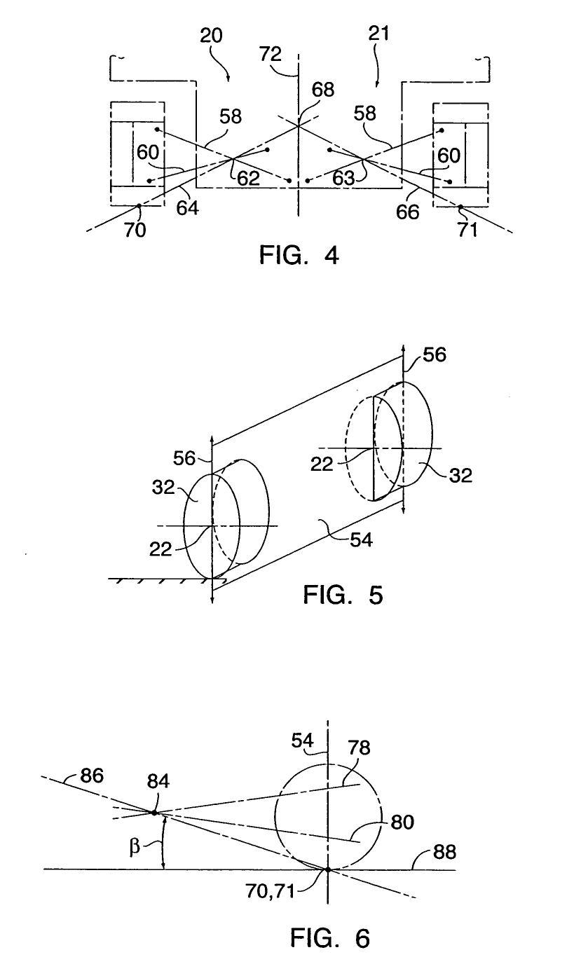

FIG. 4 shows a diagram representing a symmetrical suspension arrangement, including a pair of wheel assembly suspensions 20,21, for a pair of wheel assemblies 22 each disposed on a side of the vehicle body 28 such as that shown in FIG. 1. The diagram is shown along a vertical plane 54 that passes through the vertical centerline 56 of both wheel assemblies 22. FIG. 5 shows the plane 54 in a perspective view to better illustrate the position of the plane 54 relative to the wheel assemblies 22. The lines 58,60 formed at the intersection of each support arm plane with the vertical plane 54 are shown in FIG. 4. Note that the support arm plane intersection lines 58,60 cross one another in each suspension 20,21 when viewed in this plane 54. The intersection point 62,63 of the lines 58,60 is defined as the instant center (IC) for the front elevation view of that suspension 20,21. FIG. 4 also shows a pair of lines 64,66 that intersect at the roll center 68 of the vehicle body 28. One line 64 passes through the center of the tire ground contact patch 70 and the IC 62 on one side of the vehicle body 28. The other line 66 passes through the center of the tire ground contact patch 71 and the IC 63 on the opposite side of the vehicle body 28.

The vertical position of the roll center 68 relative to the center of gravity of the vehicle body 28 is significant because it affects the roll of the vehicle. The position of the roll center 68 can be adjusted by altering the relative positioning of the support arms 24,26 on either or both sides of the vehicle, and thereby alter the position of the IC 62,63 which is defined by the planes of the support arms 24,26. An advantage provided by the present suspension is that it is possible to create a relatively high and stable roll center 68 using a pair of the present suspensions; i.e., a relatively high roll center than can be maintained in approximately the same position during expected motion of the vehicle.

It should also be noted that the roll center shown in FIG. 4 is intersected by the vertical centerline 72 of the vehicle body 28. The roll center 68 intersects the centerline 72 because the suspensions on each side of the vehicle body 28 are symmetrical with one another. In some instances there is advantage to making the suspensions non-symmetrical and thereby cause the roll center 68 to be disposed on one side of the vehicle centerline 72. In addition, under certain loading or body movement conditions, the roll center 68 may move to either side of the vehicle centerline 72.

Referring to FIG. 6, the orientation of the support arm planes for a wheel suspension 20,21 also has important implications relative to other suspension parameters such as anti-dive, anti-squat, and anti-lift; i.e., suspension characteristics in the fore and aft direction of the vehicle (also referred to as “pitch”). FIG. 6 diagrammatically shows a side-view of a wheel assembly 22. The view is shown along a longitudinal vertical plane 74,76 that passes through the centerline of the wheels 32 on one side of the vehicle body (see FIG. 3). In FIG. 6, the wheel 32 outline is shown in phantom to locate the other elements of the drawing. The lines 78,80 formed by the intersection of the support arm planes with the plane 74,76 passing through the centerline of the wheels 32 on that side of the vehicle body 28 illustrate an embodiment where the support arm planes are not parallel to a horizontal plane 82 (see FIG. 3). The lines 78,80 can be extended to a convergence point 84 that is the instant center of the suspension 20,21 in the side view.

A line 86 extending between the side view IC 84 and the center of the tire contact patch 70,71 on the ground forms an angle β with a horizontally extending line 88 that passes through the widthwise plane 54 extending through the centerline of the wheels 32. The tangent of the angle β is directly related to the anti-dive, anti-lift, or anti-squat of the vehicle wheel assembly 22 being considered. Increasing or decreasing the magnitude of the angle β enables the adjustment of the anti-dive, anti-squat, or anti-lift to be suited to the application. The present suspension 20,21 facilitates the positioning of the convergence point 84 vertically and horizontally and thereby enables the use of a variety of advantageous β angle's for various vehicular applications. The convergence point 84 can also be positionally described in terms of a side view swing arm (svsa) height and length. The svsa height represents either: 1) the difference in vertical distance between the horizontal line 88 aligned with the wheel contact and the IC 84; or 2) the difference in vertical distance between the horizontal plane passing through the centerline of the wheel assembly and the IC. Which svsa height is appropriate depends on the position of the wheel assembly, whether it is driven, etc. The methodology to determine which is used is known and will therefore not be discussed further herein. The svsa length is the distance between the vertical centerline of the wheel assembly and the IC.

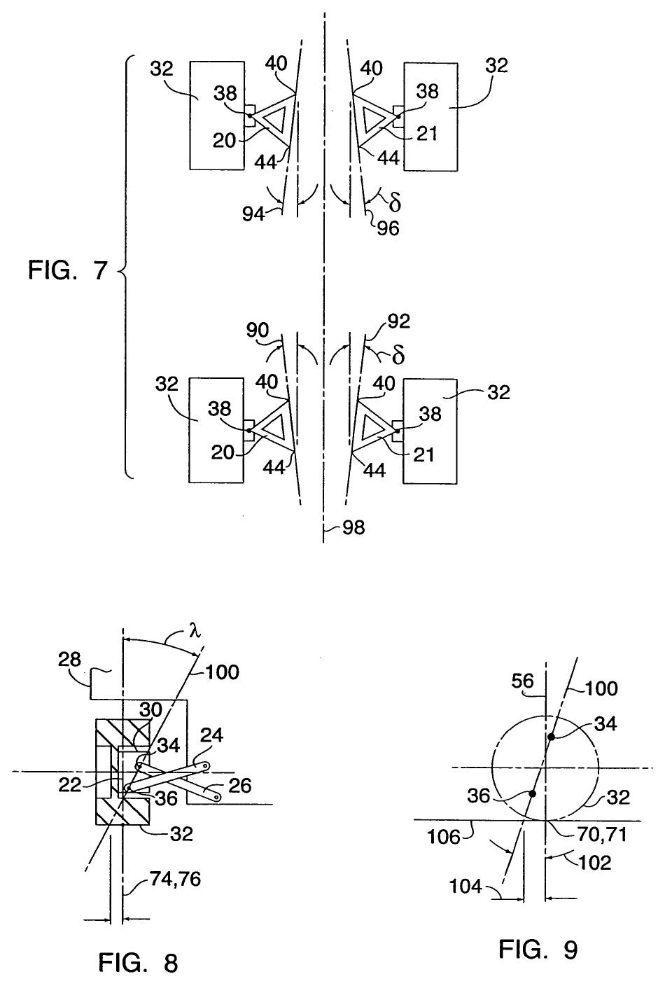

Referring to FIG. 7, the body mount line 90,92,94,96 of each support arm 24,26 can also be skewed from the longitudinally extending vertical axis 98 by an angle γ. The body mount line 90,92,94,96 is defined as a line that extends between the two body mounts 40,44 of the support arm 24,26. FIG. 7 diagrammatically shows the wheel suspensions 20,21 of a vehicle in a horizontal plane to illustrate the angle γ extending between the body mount line 90,92,94,96 of each suspension 20,21 and a longitudinal line parallel to axis 98. The suspensions 20,21 shown in FIG. 7 are all skewed by the angle δ. The exact amount of skew can vary to suit the application at hand and need not be similar between suspensions 20,21; e.g., front and rear wheel suspensions 20,21 having different skew angles, or between side to side suspensions 20,21 having different skew angles. The ability of the present suspension to be skewed from the longitudinal axis 98 of the vehicle makes it advantageously adaptable to a variety of vehicular applications.

Referring to FIG. 8, the crossed orientation of the support arms 24,26 within the present suspension facilitates positioning the ball joint mounts 34,36 relative to the wheel 32. Historically, the spindle 30 of a wheel assembly 22 pivoted about a solid axle known as a “kingpin”. Later improvements replaced the kingpin with ball joints. The line 100 between the two pivot points 34,36 is still, however, referred to as the kingpin axis (or wheel assembly mount line). As can be seen in FIG. 8, the kingpin axis 100 passing through the ball joint mounts 34,36 of the support arms 24,26 forms an angle λ relative to the vertical centerline (disposed within plane 74,76 as diagrammatically shown in FIG. 3) of the wheel 32.

In some instances, the kingpin axis 100 may be parallel to the vertical centerline 74,76 of the wheel 32 (zero degree angle—0°). In other instances, the angle between the kingpin axis 100 and the vertical centerline 74,76 is greater than zero and the kingpin axis 100 can therefore be described as extending toward (or away from) the vertical centerline 74,76. The angle of the kingpin axis 100 relative to the vertical centerline 74,76, and the position where the kingpin axis 100 intersects the vertical centerline 74,76, are both significant because of the effects they have relative to the scrub radius of the wheel 32 and the length of the spindle 30. The crossed orientation of the support arms 24,26 within the present suspension 20,21 enables the ball joint mount 38 from each support arm 24,26 to be positioned relatively close to the vertical centerline 74,76 of the wheel 32.

Referring to FIG. 9, the crossed orientation of the support arms 24,26 within the present suspension 20,21 also provides favorable positionability of the ball joint mounts 38 vis-a-vis the caster angle and the trail of the kingpin axis 100. The caster angle 102 refers to the angle of the kingpin axis 100 relative to the vertical centerline 56 of the wheel assembly 22 (or wheel 32) in the side-view of the wheel 32. The trail 104 refers to the distance between the vertical centerline 56 of the wheel 32 and the point of intersection 106 between the kingpin axis 100 and the horizontal plane 106 containing the contact patch 70,71 of the wheel 32.

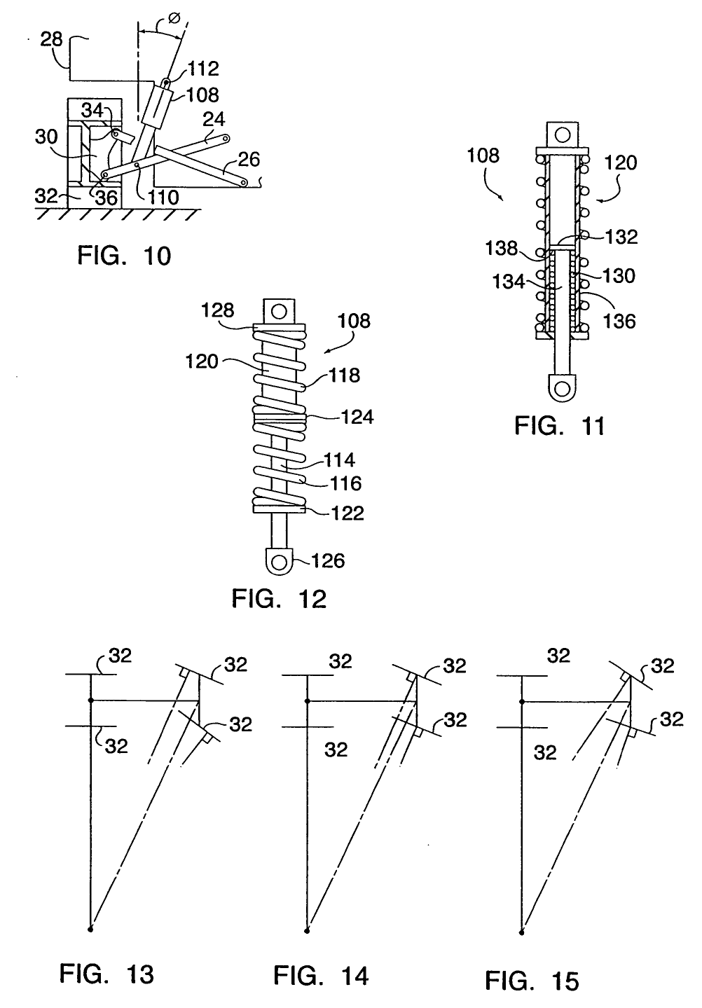

Referring to FIGS. 10-12, the present suspension 20,21 utilizes a spring assembly 108 that extends between, and is pivotally attached to, one of the support arms 24,26 (or spindle 30) and the vehicle body 28. FIG. 10 shows the spring assembly 108 attached to the support arm 24 that is pivotally attached to the lower ball joint 36, but in alternative embodiments the spring assembly 108 could be attached to the other support arm 26. In one embodiment, the spring assembly 108 is a coil over shock that includes a load bearing spring and a shock absorber. A coil spring may also be mounted independently of a shock absorber. In addition, a torsion bar may be used with or in place of a coil spring. The spring assembly 108 is mounted so that the assembly is skewed at an angle φ of approximately fifteen degrees from vertical when the wheel 32 is a normal ride height. Skewing the spring assembly 108 in this manner with the geometry of the present suspension 20,21 creates a favorable wheel load rate characteristic. Specifically, the wheel load rate decreases as the wheel 32 travels upward, in the direction toward the vehicle body 28. This occurs because the vertical component of the force transmitted through the spring assembly 108 decreases as the lower attachment point 110 of the spring assembly 108 rotates upward with the wheel 32, while the spring assembly 108 pivots about its upper pivot point 112. In some instances, more than one spring assembly is utilized, extending between the vehicle body 28 and one of the support arms 24,26 in a manner similar to that described above. The additional spring assemblies 108 may or may not include a shock absorber.

Referring to FIG. 11, in some embodiments, the spring assembly 108 includes a rebound spring 130 disposed within the shock absorber 120 that acts between the rod end 132 of the shock absorber piston 134 and the housing 136 of the shock. The rebound spring 130 is not attached to the piston 134 and therefore only acts in compression for a portion of the rod travel within the shock housing 136 beyond a predetermined engagement point 138. In circumstances where wheel assembly 22 (and therefore suspension 20,21) travel causes the spring assembly 108 to extend beyond the engagement point 138 (i.e., below “normal ride height”), the rebound spring 130 compresses and thereby opposes the travel of the suspension 20,21 and attached wheel assembly 22. In circumstances where the wheel assembly travel causes the spring assembly 108 to compress above the engagement point 138 (i.e., above normal ride height), the rebound spring 130 is not engaged and consequently has no effect on the travel of the suspension 20,21 and attached wheel assembly 22.

Referring to FIG. 12, in another embodiment, the spring assembly 108 includes a center shaft 114, a first spring 116, and a second spring 118. The spring assembly 108 further includes an additional motion damper 120. The center shaft 114 is received within the first and second springs 116,118 and the motion damper 120 is attached to the center shaft 114. Acceptable motion dampers 120 include, but are not limited to, a gas or liquid type shock absorber. The first spring 116 extends between a first end spring flange 122 and a center spring flange 124. The first end spring flange 122 is either fixed to the center shaft 114 or is travel-limited by a first stop attached to the center shaft 114. In either case, the first stop prevents the first end spring flange 122 from traveling further toward the adjacent end 126 of the spring assembly 108. The second spring 118 extends between the center spring flange 124 and a second end spring flange 128. A second stop attached to the outer body of the motion damper 120 (or other member similarly fixed) limits the travel of the center spring flange 124 and therefore the second spring 118 in the direction toward the first spring 116. The spring assembly 108 shown in FIG. 11 shows the second spring 118 disposed around the periphery of the motion damper 120.

In an uninstalled condition (or if the vehicle is lifted and the wheel assembly 22 is allowed to extend to its fully extended position), the first spring 116, which acts on and between the first end spring flange 122 and the center spring flange 124, is preferably only lightly loaded. The second spring 118, which acts on and between the second end spring flange 128 and the center spring flange 124, is preferably pre-loaded in compression by an amount appropriate for the application at hand. As the spring assembly 108 is loaded, only the first spring 116 will compress until the force provided by the first spring 116 equals or exceeds the initial pre-loaded force of the second spring 118. When only the first spring 116 is compressing, the spring assembly 108 acts as thought the first spring 116 is the only spring present; i.e., a single spring system. When the force of the first spring 116 exceeds the initial pre-loaded force of the second spring 118, the force of each spring 116,118 will equal and each spring will compress some amount. The exact amount either spring 116,118 will compress will depend on the spring rate of the particular spring. Under these conditions, the spring assembly 108 acts as though it is a twin spring system where the springs 116,118 are acting in series. As such, the center spring flange 124 can be described as floating between the first and second springs 116,118. If, for example, the first and second springs 116,118 are identical four hundred pound springs, the spring assembly 108 will initially act as though it is a single four hundred pound spring system. When the force of the first spring 116 equals that of the second spring 118, however, the spring assembly 108 will begin to act as a two spring in series system. As a result, the effective spring force of the first and second springs 116,118 acting in series will be equal to approximately one half of one of the springs acting independently; i.e., two hundred pounds.

The spring assembly 108 acts as a load path between vehicle body 28 and the suspension support arms 24,26, and ultimately between the vehicle body 28 and the wheel 32 since the four wheels 32 support the entire weight of the vehicle. The spring assembly 108 can be mounted in a variety of positions, but is preferably mounted in such a manner that the centerline of the spring assembly 108 is skewed from a vertically extending line by an angle φ as described above. The attachment points of the spring assembly 108 and the relative positions of the body mounts 40,44 and ball joint mount 38 of the support arm 24,26 to which the spring assembly 108 is attached will define the arcuate path of travel possible for the wheel assembly 22. The geometry of the present suspension support arms 24,26, the orientation of the spring assembly 108 relative to the support arm 24,28 and the vertical plane, and the twin spring characteristics of the spring assembly 108 enable the spring assembly 108 to provide a diminishing load rate to the wheel assembly 22, and therefore the wheel 32 to the ground, as the spring assembly 108 is compressed past an equilibrium point.

Referring to FIGS. 12-14, it is known to use Ackermann to account for the difference in turning radius between the vehicle wheel 32 (shown diagrammatically) disposed along the inner radius track in a turn and the vehicle wheel 32 disposed along the outer radius track. It is also known that turning can produce lift on the vehicle body. The amount of Ackermann created by the front suspension when the steering wheel is turned can be used to counteract the lift produced on the vehicle 28 body during the turn. For example, increasing the Ackermann can produce anti-lift. The support arms 24,26 of the present wheel assembly suspension 20,21 facilitate the creation of Ackermann because of their positionability relative to the vehicle body 28.

Although this invention has been shown and described with respect to the detailed embodiments thereof, it will be understood by those skilled in the art that various changes in form and detail thereof may be made without departing from the spirit and scope of the invention. For example, FIG. 1 shows a diagrammatic front view of a vehicle having a pair of the present suspensions 20,21. The support arms 24,26 of those suspensions are symmetrical and do not cross the centerline 72 of the vehicle. In alternative embodiments, the support arms 24,26 of one or both suspensions 20,21 may cross the centerline 72, and potentially cross each other. Extending the support arms 24,26 can provide favorable camber characteristics for a wheel assembly 22.

As discussed previously, an important aspect of the suspension geometry according to the present invention is to create a high roll center that exhibits minimal movement as the wheel moves through its travel. The orientation of the support, or control, arms of the suspension system define the roll center of the vehicle. The control arms control the majority of the camber change as the wheel moves up and down through its travel. It will be readily appreciated that various known spring and shock elements may be selectively attached to one or more of the control arms of the suspension system without departing from the broader aspects of the present invention.

Another important aspect of the present invention is understanding that the roll center is not defined by steering links. Steering links merely assist in controlling the majority of the toe change as the wheel moves up and down during its travel. The geometry of the suspension systems of the present invention may be applied equally well in conjunction with any steering system/links typically found on the front or rear of known vehicles.

While it is known in the art that high roll center suspensions exhibit reduced vehicle roll during cornering, the present invention also facilitates anti-dive, anti-lift, and anti-squat dynamics. The anti-dive dynamics of the suspension system of the present invention acts to reduce lowering of the front of the vehicle during braking, if applied to the front wheel assemblies of the vehicle. The anti-lift dynamics of the suspension system of the present invention acts to reduce rising of the rear of the vehicle during braking, if applied to the rear wheel assemblies of the vehicle. The anti-squat dynamics of the suspension system of the present invention act to reduce lowering of the rear of the vehicle during acceleration, if applied to the rear wheel assemblies of the vehicle.

FIG. 16 illustrates a diagrammatic isometric view of yet another embodiment of the suspension system 300 of the present invention. As shown in FIG. 1, a transverse, vertical plane 302 passes through a centerline of a wheel assembly 304, passing through the center C of the wheel assembly 304, and is substantially perpendicular to the longitudinal axis X of a vehicle body 306, schematically represented in broken lines in FIG. 16. The wheel assembly 304 rotates via a bearing, or the like, disposed inside a known spindle/knuckle assembly 310.

The spindle/knuckle assembly 310 is schematically shown in FIG. 16 and may take many different forms and configurations without departing from the broader aspects of the present invention. In typical applications, the spindle/knuckle assembly 310 may include an attachment point for an unillustrated steering link which is positioned farther forward than the control arm attachment points on the spindle/knuckle assembly 310, in the case of ‘front-steer’ vehicles. In the case of ‘rear-steer’ vehicles, the steering link attachment point is positioned farther rearward than the control arm attachment points. The steering link attachment point on the spindle/knuckle assembly 310 is not shown, for clarity.

As shown in FIG. 16, the suspension system 300 includes an upper control arm 312 attached to the spindle/knuckle assembly 310 vertically above the center C of the wheel assembly 304. In a preferred embodiment, the upper control arm 312 is a single, two degree of restriction member such as an “A-arm.” In this embodiment, the upper control arm 312 will have two vehicle attachment points 314 on the vehicle body 306 and one wheel assembly attachment point 316 on the spindle/knuckle assembly 304. As understood in the art, a degree of restriction refers to how many degrees of freedom at the spindle/knuckle are controlled by the member/control arm. It will be readily appreciated that the vehicle attachment points 314, and the wheel assembly attachment point 316, are affixed for rotational movement.

In accordance with the present invention, the upper control arm 312 need not take the form of an A-frame, as shown in FIG. 16. Alternatively, the upper control arm 312 may be comprised of two separate control arms, each having a single degree of restriction. In this alternate embodiment, each of the two separate upper control arms will have one attachment point on the body 306 and one attachment point on the spindle/knuckle assembly 310 vertically above the center C of the wheel assembly 304.

Moreover, the upper control arm 312 may also be comprised of a single control arm having a single degree of restriction. This single control arm has one attachment point on the body 306 and one attachment point on the spindle/knuckle assembly 304, vertically above the center C of the wheel assembly 304. This embodiment requires a longitudinally oriented, non-steering member having single degree of freedom and one attachment point on the body 306 and one attachment point on the spindle/knuckle assembly 304, oriented vertically in-between the attachment point of the upper control arm 312 on the spindle/knuckle assembly 310 and the attachment point of a lower control arm 318 on the spindle/knuckle assembly 310, as will be discussed below.

Still referring to FIG. 16, the suspension system 300 includes the lower control arm 318 attached to the spindle/knuckle 318 oriented vertically below the center C of the wheel assembly 304. In a preferred embodiment, the lower control arm 318 is a single, two degree of restriction member such as an “A-arm.” In this embodiment, the lower control arm 318 will have two vehicle attachment points 320 on the body 306, and one wheel assembly attachment point 322 on the spindle/knuckle assembly 304. It will be readily appreciated that the vehicle attachment points 320, and the wheel assembly attachment point 322, are affixed for rotational movement.

In accordance with the present invention, the lower control arm 318 need not take the form of an A-frame, as shown in FIG. 16. Alternatively, the lower control arm 318 may be comprised of two separate control arms, each having a single degree of restriction. In this alternative embodiment, each of the two separate lower control arms will have one attachment point on the body 306 and one attachment point on the spindle/knuckle assembly 304, oriented vertically below the center C of the wheel assembly 304.

Moreover, the lower control arm 318 may also be comprised of a single control arm having a single degree of restriction. This single control arm has one attachment point on the body 306 and one attachment point on the spindle/knuckle assembly 304, vertically above the center C of the wheel assembly 304. This embodiment requires a longitudinally oriented, non-steering member having single degree of freedom and one attachment point on the body 306 and one attachment point on the spindle/knuckle assembly 304, oriented vertically in-between the attachment point of the upper control arm 312 on the spindle/knuckle assembly 310 and the attachment point of the lower control arm 318 on the spindle/knuckle assembly 310.

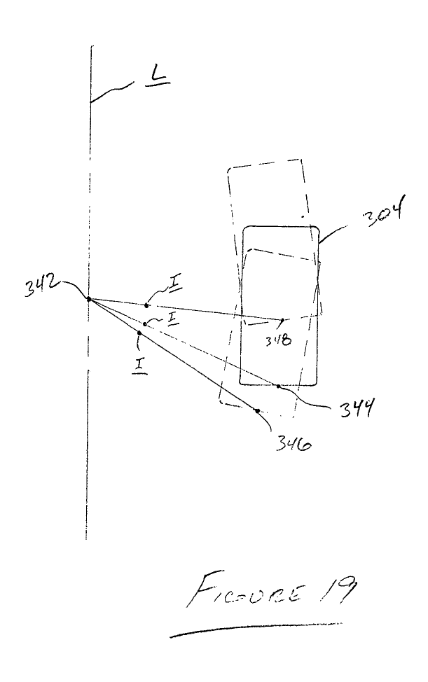

Referring to FIG. 17, a front view of the suspension system 300 of FIG. 16 is shown, including the wheel assembly 304 and a ground plane 324 in contact with the wheel assembly 304. As shown in FIG. 17, an upper control arm line segment 326, and a lower control arm line segment 328, are defined. As is also shown in FIG. 17, the upper control arm line segment 326 is shorter than the lower control arm line segment 328, in accordance with a preferred embodiment of the present invention.

The line segments, 326 and 328, illustrated in FIG. 17 are formed by the intersection of the transverse plane 302 and the planes defined by the upper control arms 312 and the lower control arms 318. In particular, the upper line segment 326 is formed by the intersection of the transverse plane 302 and the plane defined by the attachment points, 314 and 316, of the A-arm upper control arm 312 shown in FIG. 16. Similarly, the lower line segment 328 is formed by the intersection of the transverse plane 302 and the plane defined by the attachment points, 320 and 322, of the A-arm lower control arm 318, also shown in FIG. 16.

In the alternative embodiment of the upper control arm 312 which includes two separate control arms, discussed previously, the upper line segment 326 is formed by the intersection of the transverse plane 302 and the plane defined by the attachment points 314 on the vehicle body 306 of each upper control arm and the midpoint 338 of the line segment connecting the upper attachment points of the each upper control arm to the spindle/kingpin assembly 304, as shown in FIG. 18. Similarly, the lower line segment 328 is formed by the intersection of the transverse plane 302 and the plane defined by the attachment points 320 on the vehicle body 306 of each lower control arm and the midpoint 340 of the line segment connecting the lower attachment points of the each lower control arm to the spindle/kingpin assembly 304, as is also shown in FIG. 18.

In yet another alternative embodiment of the suspension system of the present invention, where the upper control arm 312 is formed of a single control arm, the upper line segment 326 is formed by the intersection of the transverse plane 302 and the plane of the single upper control arm defined as being parallel to the longitudinal axis of the vehicle and passing through the line created by the endpoints of the substantially transverse single, upper control arm. Similarly, when the lower control arm 312 is formed of a single control arm, the lower line segment 328 is formed by the intersection of the transverse plane 302 and the plane of the single lower control arm defined as being parallel to the longitudinal axis of the vehicle and passing through the line created by the endpoints of the substantially transverse single lower control arm.

This embodiment requires a longitudinally oriented, non-steering member having single degree of freedom and one attachment point on the body 306 and one attachment point on the spindle/knuckle assembly 304, oriented vertically in-between the attachment point of the upper control arm 312 on the spindle/knuckle assembly 310 and the attachment point of a lower control arm 318 on the spindle/knuckle assembly 310

Having now explained the formation of the line segments, 326 and 328, the determination of the endpoints of these line segments will now be discussed. As shown in FIG. 17, the upper line segment 326 includes an upper first endpoint 330. The upper first endpoint 330 of the upper control arm line segment 326 is defined by the upper control arm attachment point 316 on the spindle/kingpin assembly 304 as projected onto the transverse plane 302, and as viewed from the front of the vehicle. Similarly, the first endpoint 332 of the lower control arm line segment 328 is defined by the lower control arm attachment point 322 on the spindle/kingpin assembly 304 as projected onto the transverse plane 302, and as viewed from the front of the vehicle.

As shown in FIG. 17, an upper second endpoint 334 of the upper control arm line segment 326 is defined by the intersection of the transverse plane 302 and a line extending through the vehicle attachment points 314, as shown in FIG. 16. This determination of the upper second endpoint 334 applies both where the upper control arms 312 are formed as an A-arm, or as two separate control arms. Alternatively, in the embodiment where the upper control arm 312 is formed of a single control arm, the upper second endpoint 334 is defined by the vehicle attachment point of the single upper control arm as projected onto the transverse plane 302, and as viewed from the front of the vehicle.

Similarly, a lower second endpoint 336 of the lower control arm line segment 328 is defined by the intersection of the transverse plane 302 and a line extending through the vehicle attachment points 320, as shown in FIG. 16. This determination of the upper second endpoint 334 applies both where the lower control arms 318 are formed as an A-arm, or as two separate control arms. Alternatively, in the embodiment where the lower control arm 318 is formed of a single control arm, the lower second endpoint 336 is defined by the vehicle attachment point of the single lower control arm as projected onto the transverse plane 302, and as viewed from the front of the vehicle.

In accordance with another important aspect of the present invention, an extension 340 of the upper line segment 334 is oriented so as to intersect the lower line segment 328 at the instant center I of the suspension system 300. That is, an important aspect of the present invention lies in the recognition that the upper line segment 326 and the lower line segment 328 need not actually cross one another in superposition, provided that the upper control arms 312 and the lower control arms 318 are arranged in a manner such that an extension of the line segments, 326 and 328, intersect at the instant center I of the suspension system 300.

Another important aspect of the present invention lies in ensuring that the roll center of the vehicle 306 lies above the ride-height instant center for each wheel assembly, and that the instant center of each wheel assembly be oriented on the same side of the longitudinal vehicle center line as is each wheel assembly.

Operation of the suspension system 300 will now be explained in conjunction with FIG. 19. As shown in FIG. 19, the wheel assembly 304 is shown in relation to the centerline L of the vehicle 306, as viewed from the front of the vehicle 306, and roll force center 342 of the vehicle body 306. As the wheel assembly 304 moves upwards, the instant center (10) moves upwards. As the wheel/tire (2) moves downwards, the instant center I will move downwards. When the wheel assembly 304 is at normal driving position with respect to the vehicle body 306 such as when the vehicle 306 is driving straight on a smooth highway, a line through the center 344 of the ‘ride height’ tire-ground contact patch and the instant center I of the suspension system 300 intersects the centerline L of the vehicle 306 at the roll force center 342. When the wheel assembly 304 is as far below the vehicle body 306 as the suspension system 300 will allow, a line through the center 346 of the ‘full rebound’ tire-ground contact patch and the instant center I of the suspension system 300 intersects the centerline L of the vehicle 306 at the roll force center 342. Similarly, when the wheel assembly 304 is as far up towards the vehicle body 306 as the suspension system 300 will allow, a line through the center 348 of the ‘full jounce’ tire-ground contact patch and the instant center I of the suspension system 300 also intersects the centerline L of the vehicle 306 at the roll force center 342.

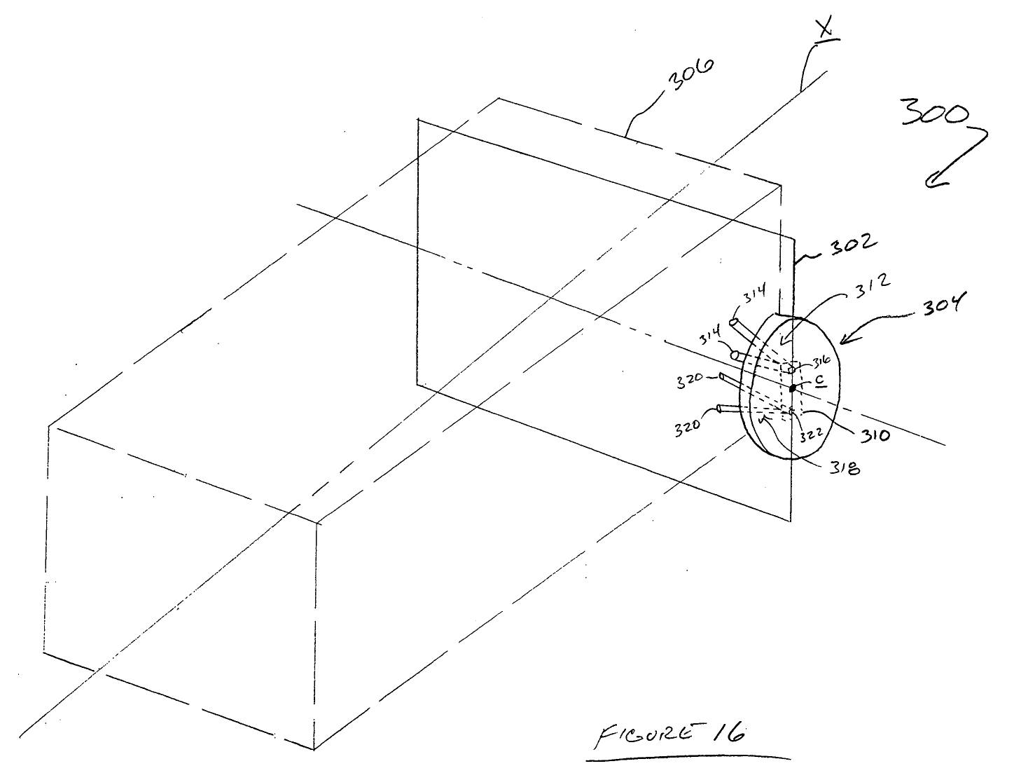

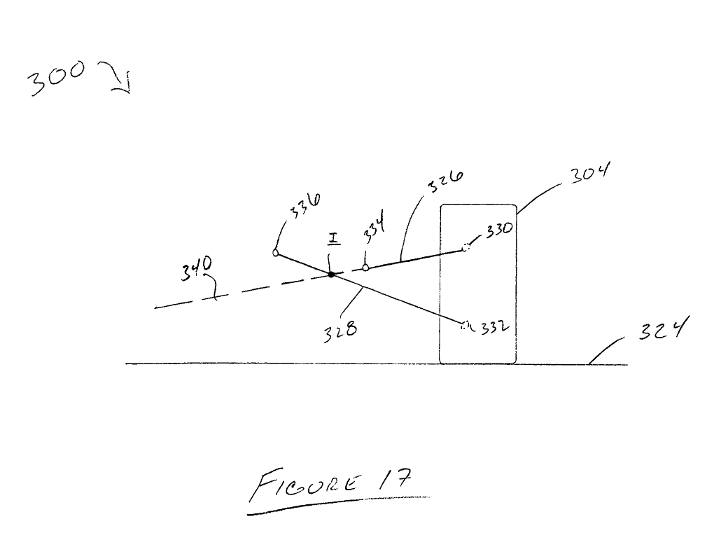

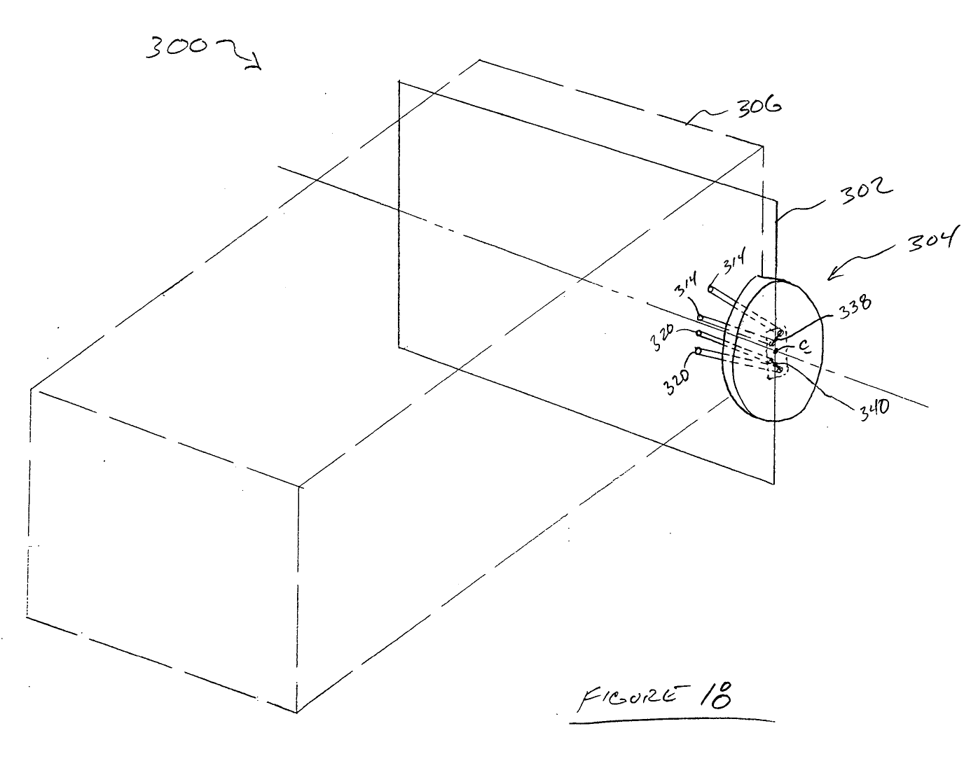

As is known in the art, the roll center of a vehicle is determined by projecting a line from the center of the tire-ground contact patch through the front view of the instant center. It is therefore an important aspect of the present invention that, as shown in FIG. 19, the location of the roll force center 342 is kept substantially constant as the wheel assembly 304 moves through its path, from a full jounce, or bounce, position to a full rebound position. Moreover, by configuring upper and lower control arms, 312 and 318, in the manner discussed in conjunction with FIGS. 16-18, the present invention may ensure that a line drawn from the center of the tire-ground contact patch through the front view of the instant center I results in substantially the same roll center for the vehicle 306, thus reducing vehicle roll while also creating anti-dive, anti-lift and anti-squat dynamics. It will be readily appreciated that the suspension system 300 may be adapted to the front wheel assemblies of a vehicle, to the rear wheel assemblies of a vehicles or to both. Moreover, the suspension systems discussed in connection with FIGS. 1-19 may also be applied to non-wheel vehicles, such as but not limited to track or tread vehicles, without departing from the broader aspects of the present invention.

What is claimed is:

1. A suspension for a vehicle having a body having a vehicle roll center, the suspension comprising:
a first suspension assembly that extends between a first wheel assembly and the body, wherein the first suspension assembly defines an instant center;
a second suspension assembly that extends between a second wheel assembly and the body, wherein the second suspension assembly defines an instant center;
wherein the first wheel assembly and the second wheel assembly are aligned so that a vertical centerline of each wheel assembly lies within a vertical plane that extends therebetween; and
wherein the instant center of each wheel assembly suspension is located within the vertical plane, below said roll center located within the vertical plane.

2. A suspension for a vehicle having a body, the suspension comprising:
a first control arm that extends between a wheel assembly and said body, wherein said first control arm defines a first suspension plane;
a second control arm that extends between said wheel assembly and said body, wherein said second control arm defines a second suspension plane;
a vertical plane extending through a vertical centerline of said wheel assembly;
wherein an intersection between said vertical plane and said first suspension plane defines a first line, and an intersection between said vertical plane and said second suspension plane defines a second line, said first line and said second line intersecting at an instant center which lies below a roll center of said vehicle; and
wherein said first control arm and said second control arm do not cross one another when said first wheel assembly is viewed from one of a front and rear of said vehicle.

3. A suspension system for a vehicle, said suspension system comprising:
a first suspension arm having two degrees of restriction and rotatably fixed between a wheel assembly and said body, wherein said first suspension arm defines a first suspension plane;
a second suspension arm having two degrees of restriction and rotatably fixed between said wheel assembly and said body, wherein said second suspension arm defines a second suspension plane;
a vertical plane extending through a vertical centerline of said wheel assembly;
wherein an intersection between said vertical plane and said first suspension plane defines a first line, and an intersection between said vertical plane and said second suspension plane defines a second line, said first line and said second line intersecting at an instant center which lies below a roll center of said vehicle; and
wherein said first suspension arm is shorter than said second suspension arm.
